(19) United States
(12) Patent Application Publication
(10) Pub. No.: US 2026/0253940 A1
(43) Pub. Date: Aug. 27, 2026

(54) Vertical Stack Solid-State Batteries

(71) Applicant: FORD GLOBAL TECHNOLOGIES, LLC, Dearborn, MI (US)

(72) Inventors: Chansun PARK, Southfield, MI (US); Justin PUREWAL, Ann Arbor, MI (US); Brian Joseph ROBERT, St. Clair Shores, MI (US); Matthew DENLINGER, Ferndale, MI (US); Andrew Robert DREWS, Ann Arbor, MI (US)

(21) Appl. No.: 19/054,265

(22) Filed: Feb. 14, 2025

(51) Int. Cl. H01M 10/04; H01M 4/62; H01M 10/0525; H01M 10/0562; H01M 10/0585; H01M 50/107; H01M 50/434

(52) U.S. Cl. CPC H01M 10/0468; H01M 4/624; H01M 10/049; H01M 10/0525; H01M 10/0562; H01M 10/0585; H01M 50/107; H01M 50/434; H01M 2300/0071

(57) ABSTRACT

A solid-state battery cell is presented. The solid-state battery cell has a bipolar stack including a pair of electrode assemblies, each in electrical contact with and compressed against opposite sides of a sintered metal foil current collector. The battery cell further includes a metal powder layer positioned atop the bipolar stack.

### TECHNICAL FIELD

This disclosure relates to vertically stacked solid-state batteries for lithium-ion batteries.

### BACKGROUND

Solid-state batteries offer potential advantages in energy density by utilizing a solid electrolyte instead of a liquid one. Current manufacturing processes for solid-state batteries often adapt methods from liquid electrolyte-based battery production, such as slurry coating, which uses solvents, binders, and metal foils.

### SUMMARY

A solid-state battery cell includes a bipolar stack with a pair of electrode assemblies, each in electrical contact and compressed with opposite sides of a sintered metal foil current collector, and a metal powder layered atop the bipolar stack. Each electrode assembly may include a lithium layered oxide cathode. Each electrode assembly may include a silicon-based anode. Each electrode assembly may include a carbon-based additive. Each electrode assembly may include an oxide-based solid electrolyte separator. The oxide-based solid electrolyte separator may be selected from a group including lithium aluminum titanium phosphate and lithium lanthanum zirconium oxide. The bipolar stack may include a manganese dioxide electrochemical double-layer capacitor catholyte.

A method of forming a solid-state battery includes depositing metal powder into a cylindrical cell container and distributing the powder to form a discrete layer between alternating electrode assembly precursor powder layers to form a stack, and thermocompressing the stack to sinter the metal layers into solid current collectors and the electrode assembly precursor powder layers into solid electrode assemblies to establish interparticle connections therebetween to form a solid-state battery. The method may include applying a localized heat treatment. The method may also include kinetic deposition, thermal spray deposition, or cold spray. The electrode assembly precursor powder layers may include lithium metal oxide particles. In some configurations of the method, a solid electrolyte precursor may be included between the electrode assembly precursor powder layers prior to thermocompression. Thermocompression may be performed at a temperature below 1,000°C. Electrode assembly precursor powder layers may include a binder additive.

A method of forming vertical stack battery includes electrode assembly particle layers being interleaved between metal pellet layers within a cylindrical cell, and heat and pressure being applied to the cylindrical cell to compact and sinter the metal pellet layers into solid current collectors and the electrode assembly particle layers into electrode assemblies bonding the current collectors to adjacent electrode assemblies to create a solid-state battery structure. The electrode assembly particle layers may include a mixture of an active material, a conductive additive, and a solid electrolyte. The cylindrical cell may include a polymer lining to contain the interleaved layers during heating and compression. Heat may be applied to the cylindrical cell below 1,000°C. Pressure may be applied to the cylindrical cell is in a range of 50 MPa to 150 MPa. In some configurations the method may include a step where the resulting solid-state battery structure is encapsulated in a ceramic housing. Heat and pressure may be applied simultaneously using an induction heating press.

### BRIEF DESCRIPTION OF THE DRAWINGS

FIGS. 1-3 are schematic diagrams of vertically stacked solid-state batteries;

FIGS. 4A-G are schematic diagrams of an electrode manufacture process for vertically stacked solid-state batteries; and

FIGS. 5A-E are schematic diagrams of a vertically stacked solid-state battery assembly process.

### DETAILED DESCRIPTION

As required, detailed embodiments of the claimed subject matter are disclosed herein; however, it is to be understood that the disclosed embodiments are merely representative and may be embodied in various and alternative forms. The figures provided are not necessarily to scale, with some features exaggerated or minimized to illustrate specific details. For instance, particular structural and functional details, such as the composition of the solid electrolyte (e.g., lithium lanthanum zirconium oxide), the dry pelletized anode and cathode materials, and the cylindrical cell configuration with bipolar stacking, are not to be interpreted as limiting. Instead, they serve as illustrative examples for teaching those skilled in the art how to apply the principles of the claimed subject matter to various embodiments in solid-state battery technology.

Unless otherwise explicitly specified, all numerical values and ranges relating to temperatures, pressures, and similar references within this document are to be understood as being preceded by the term “about.” This applies even in cases where the term “about” is not explicitly stated. It is intended that all values and ranges include variations resulting from standard manufacturing processes, equipment tolerances, and material properties. For example, when sintering temperatures are described as “1,100° C,” this should be understood as “about 1,100° C.” Similarly, when compression pressures are stated as “50–200 MPa,” this range should be interpreted as “about 50 to about 200 MPa.” Such variations are implicitly encompassed within the scope of this disclosure, including all processes, parameters, and methods described in the following claims.

Solid-state batteries (SSBs) are an emerging alternative to conventional liquid electrolyte-based lithium-ion batteries, offering potentially higher energy density. A feature of SSBs is the use of solid electrolytes.

SSB manufacturing faces challenges related to scalability and form factor flexibility. Current manufacturing processes often adopt techniques developed for liquid electrolyte batteries, such as slurry coating, which involves solvents, binders, and metal foils. These techniques may not be ideal for SSB production as they rely on solvents, such as N-methyl-2-pyrrolidone, and increase complexity due to solvent recovery and drying requirements. Furthermore, mechanical fragility of electrodes produced through slurry coating may limit the ability to produce rolled cylindrical cells. As a result, current SSBs are largely confined to pouch and prismatic form factors, which may be less versatile than cylindrical configurations.

Current collectors, typically made from copper or aluminum foil, do not contribute to a battery’s electrochemical capacity. Additionally, the space occupied by current collectors reduces volume available for active materials. Reducing or eliminating current collector materials may increase performance in SSBs.

To address these challenges, a process for SSB fabrication that eliminates the need for slurry-based solvents and increases the structural integrity of electrodes is proposed. This process utilizes dry compression or pelletizing of battery material powders to form solid building blocks, which are subsequently sintered at elevated temperatures to reduce electrode-electrolyte interface resistance. The building blocks are then vertically stacked into a cylindrical cell using a bipolar configuration.

The dry pelletizing process involves compressing active material powders, including lithium lanthanum zirconium oxide as the solid electrolyte, along with cathode and anode materials. Compression pressures between 50-200 MPa are used to densify the powders, and the resulting pellets are sintered at temperatures of approximately from 1,100-1,200°C to increase ionic conductivity and reduce grain boundary resistance. This sintering step creates strong interfaces between the solid electrolyte and active materials, increasing overall battery performance.

A bipolar stacking configuration further increases energy density by eliminating the need for tabs in the cell assembly. In this design, metal powders, such as copper or aluminum, are used to form thin, in situ current collectors between the pellets. These powders are deposited and sintered locally using temperatures ranging from 300-500°C to form uniform, low-resistance interfaces. This approach reduces the amount of current collector material required and increases packaging efficiency. Alternatively, methods such as plasma deposition or metal spray may be used to deposit metal powder layers.

The cylindrical form factor is achieved by stacking the sintered pellets vertically inside a cylindrical casing. The casing may also be either hexagonal, rectangular, or any other suitable casing shape. To prevent short circuits, an insulating layer made of materials such as rubber or ceramics may be applied to inner walls of the cylindrical casing. This configuration maintains alignment of the electrodes, eliminating the need for overhanging anode material, a common feature in traditional stacked cells designed to accommodate misalignments.

Unlike traditional cylindrical cells, which rely on wound electrode configurations and face limitations due to tight radii, the proposed pelletized stacking method accommodates a wide variety of shapes and sizes. This flexibility allows for the optimization of cell dimensions to achieve desired voltage and capacity levels. The bipolar cylindrical SSB design offers higher energy density compared to existing cylindrical lithium-ion cells, such as 4680 and 21700 formats, by eliminating tab mass and volume and enabling the use of thinner current collectors.

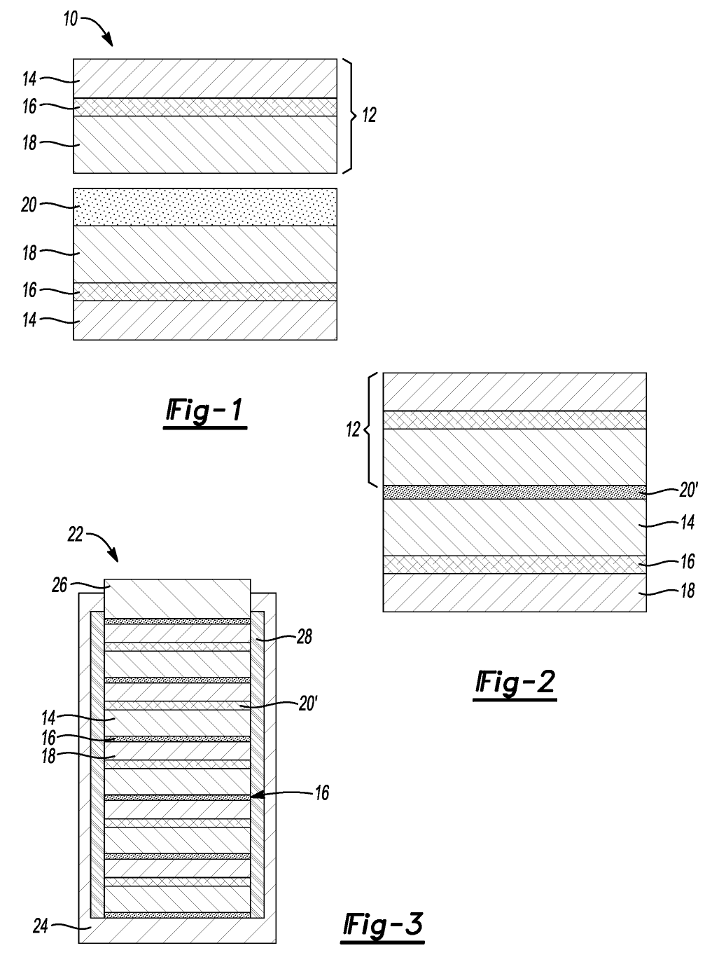

FIGS. 1-3 show schematic diagrams of vertically stacked solid-state batteries. FIG. 1 is a schematic cross-sectional view of a vertical stack SSB 10 in a bipolar configuration. The vertical stack SSB 10 includes an electrode assembly 12, with a cathode layer 14, a separator layer 16, and an anode layer 18. The cathode 14 may be composed of lithium-layered oxide materials, such as lithium nickel manganese cobalt oxide or lithium cobalt oxide. These materials may provide high energy density and stability. A catholyte in the cathode 14 may include electric double-layer capacitor materials, such as manganese dioxide, which may increase ionic and electronic conductivity. Additionally, carbon additives such as carbon black, graphene, or carbon nanotubes may be incorporated in cathode 14 to increase electrical conductivity.

The separator 16 may be a solid electrolyte layer made from oxide-based solid electrolyte materials, such as lithium lanthanum zirconium oxide, lithium lanthanum titanium oxide, or lithium super ionic conductor. These materials may provide high ionic conductivity while maintaining mechanical stability and thermal resistance.

The anode 18 may include materials such as graphite, silicon, or silicon-carbon composites, which have high specific capacity. An anolyte in the anode 18 may also include electric double-layer capacitor materials, such as manganese dioxide to further increase conductivity, alongside carbon additives such as carbon black, graphene, or carbon nanotubes to increase electrical performance.

Positioned atop the electrode assembly is a metal powder layer 20, which may be made of conductive metal powders. This metal powder layer 20 serves as a precursor for forming integrated current collectors during subsequent sintering processes.

FIG. 2 shows an intermediate stage of the SSB fabrication process, where the metal powder layer 20 has undergone sintering and compaction to form a dense, uniform current collector layer 20’. The sintering process may involve heating the metal powder layer 20 to temperatures below 1000–1200°C, causing the particles to fuse into a cohesive layer. This approach creates a low-resistance interface between electrode assemblies, increasing electrical conductivity while minimizing material thickness and weight.

FIG. 3 shows a vertically stacked cylindrical SSB 22 enclosed within a cylindrical can 24. A cap 26 is used to seal the vertically stacked cylindrical SSB 22 and provide terminals for external electrical connections. Alternating layers of electrode assemblies 12 are stacked in a bipolar configuration with current collector layers 20’ there between. An insulating layer 28, may be composed of materials such as rubber or ceramics, lines the inner walls of the cylindrical can 24 to maintain electrical isolation.

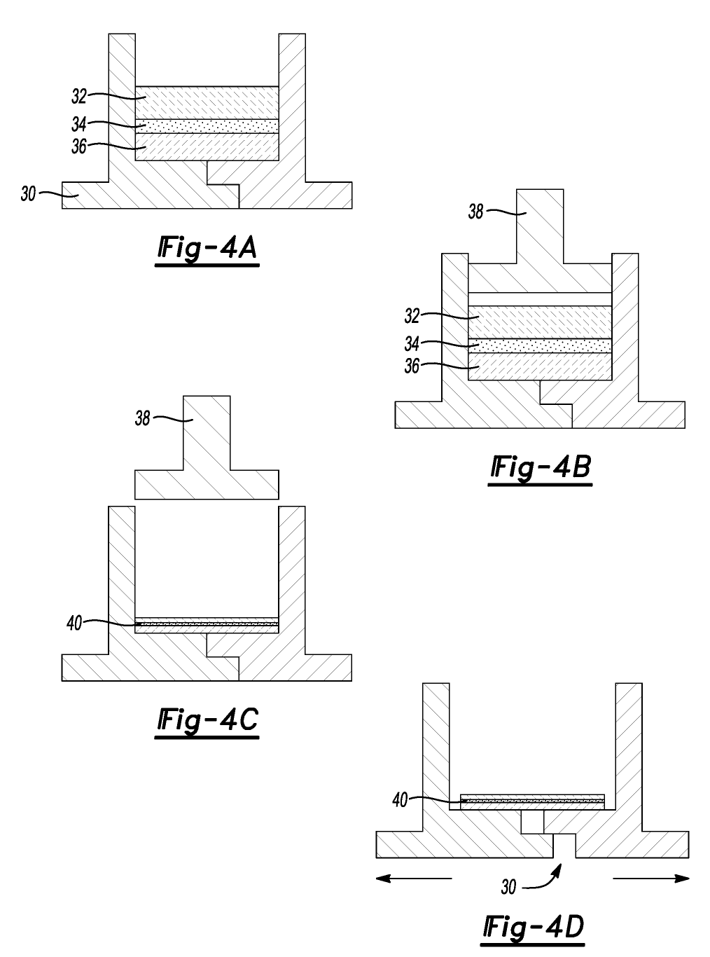

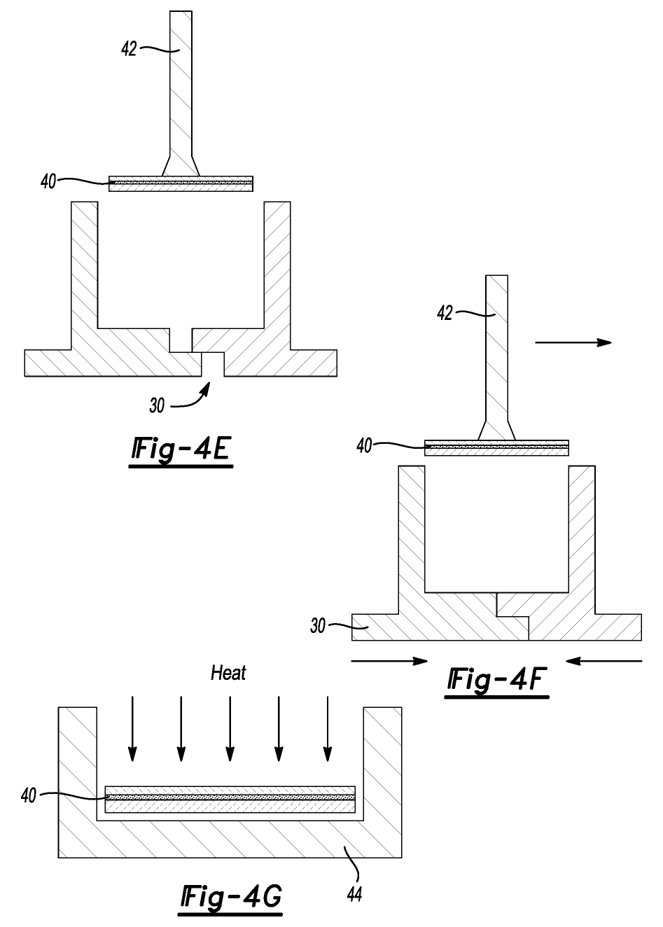

FIG. 4A-G show a process of manufacturing electrodes for SSBs. FIG. 4A shows an initial setup for a pelletizing process, where a die 30 contains a layered stack of battery material powders. The layers include a cathode material layer 32, a solid electrolyte layer 34, and an anode material layer 36, all deposited sequentially.

FIG. 4B shows a plunger 38 pressing the cathode material layer 32, the solid electrolyte layer 34, and the anode material layer 36 within the die 30. This compression process consolidates the powder layers into a denser form, to increase mechanical stability and interfacial contact between layers. Compression pressures typically range from 50 to 200 MPa to achieve optimal density and cohesion of the powder layers.

FIG. 4C shows formation of a compressed electrode 40 after the pressing operation in FIG. 4B. The compressed electrode 40 maintains the layered structure of the cathode material layer 32, the solid electrolyte layer 34, and the anode material layer 36.

FIG. 4D shows separation of the die 30 into two parts to allow for the removal of the compressed electrode 40. This die separation step ensures that the compressed electrode 40 is not altered or deformed during extraction.

FIG. 4E shows a suction device 42 used to lift the compressed electrode 40 from the die 30. The suction device 42 is designed to securely hold the compressed electrode 40 without applying excessive force, preventing any degradation.

FIGS. 4F-G show the placement of the compressed electrode 40 into a sintering platform 44. The sintering platform 44 is configured to maintain alignment and structural integrity of the compressed electrode 40 during the sintering process.

In FIG. 4G the compressed electrode 40 is sintered at high temperatures within the platform 44. The sintering process involves heating the pellet to temperatures up to 600°C, which causes the material particles of the compressed electrode 40 to fuse at their boundaries. This step increases ionic conductivity and mechanical strength while reducing grain boundary resistance.

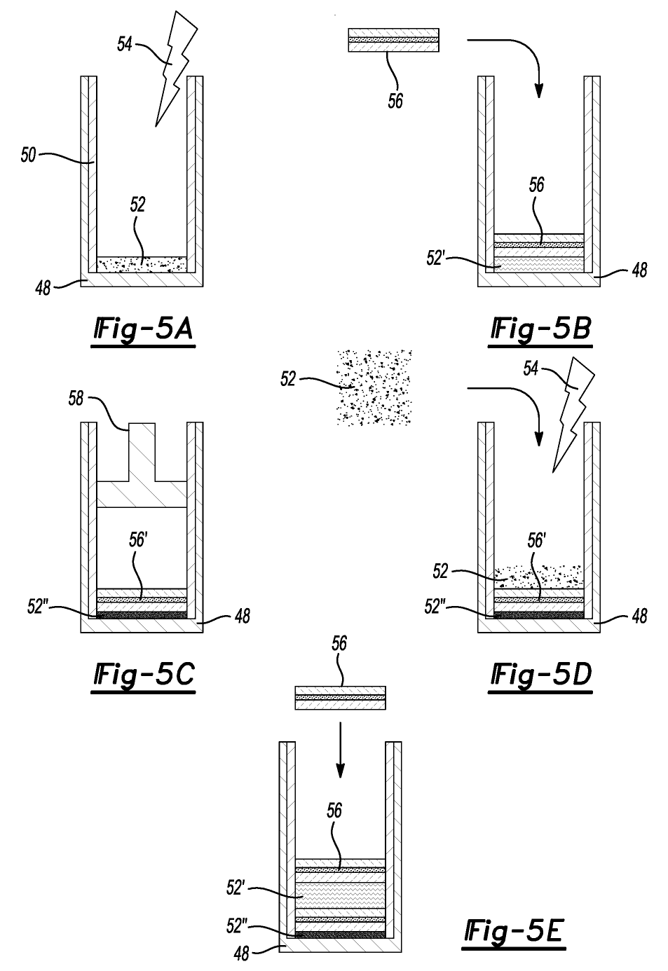

FIGS. 5A-E are schematic diagrams of a vertically stacked solid-state battery assembly process. FIGS. 5A-B show an initial step of forming a bipolar stack in a cylindrical SSB assembly. A cylindrical housing 48, lined with a gasket insulator 50, serves as a container for the SSB assembly. A metal powder layer 52, composed of materials such as copper or aluminum, is deposited into the bottom of the cylindrical housing 48. The metal powder 52 is then subjected to an electric or thermal treatment 54 to partially melt or sinter the powder, forming a conductive current collector 52’.

FIG. 5B shows the insertion of a pre-fabricated electrode assembly 56 into the cylindrical housing 48. The pre-fabricated electrode assembly 56 includes stacked layers of cathode, solid electrolyte, and anode materials, as previously described. The pre-fabricated electrode assembly 56 is aligned with the conductive current collector 52’ to maintain electrical and mechanical integrity.

FIG. 5C shows a pressing operation performed using a plunger 58. The plunger compresses the pre-fabricated electrode assembly 56 against the current collector 52’, creating strong adhesion. This compression step forms a compressed electrode assembly 56’ and a thin conductive current collector 52’’. The compression also increases mechanical robustness of the assembly as well as ionic and electronic conductivity at the interface of the compressed electrode assembly 56’ and the thin conductive current collector 52’’.

FIGS. 5D-E show the addition of a second metal powder layer 52 over the compressed electrode assembly 56’. Similar to the process in FIG. 5A, the metal powder is deposited and subjected to an electric or thermal treatment 54. This step creates a second conductive current collector layer 52’ atop the compressed electrode assembly 56’, which serves as the foundation for subsequent layers of a bipolar vertically stacked SSB.

In FIG. 5E another pre-fabricated electrode assembly 56 is inserted atop the second conductive current collector 52’. The processes in FIGS. 5C-E may be iteratively repeated to form a complete bipolar vertically stacked SSB.

While representative embodiments are described above, it is not intended that these embodiments describe all possible forms of the invention. The words used in the specification are words of description rather than limitation, and it is understood that various changes may be made without departing from the claimed subject matter. Additionally, the features of various implementing embodiments may be combined to form further embodiments within the scope of the claimed subject matter that are not explicitly described or illustrated.

What is claimed is:

1. A solid-state battery cell comprising:
a bipolar stack with a pair of electrode assemblies, each in electrical contact and compressed with opposite sides of a sintered metal foil current collector; and
a metal powder layered atop the bipolar stack.

2. The solid-state battery cell of claim 1 wherein each electrode assembly includes a lithium layered oxide cathode.

3. The solid-state battery cell of claim 1 wherein each electrode assembly includes a silicon-based anode.

4. The solid-state battery cell of claim 1 wherein each electrode assembly includes a carbon-based additive.

5. The solid-state battery cell of claim 1 wherein each electrode assembly includes an oxide-based solid electrolyte separator.

6. The solid-state battery cell of claim 5 wherein the oxide-based solid electrolyte separator is selected from a group including lithium aluminum titanium phosphate and lithium lanthanum zirconium oxide.

7. The solid-state battery cell of claim 1 wherein the bipolar stack includes a manganese dioxide electrochemical double-layer capacitor catholyte.

8. A method of forming a solid-state battery comprising:
pouring metal layers of powder into a cylindrical cell between alternating electrode assembly precursor powder layers to form a stack; and
thermocompressing the stack to sinter the metal layers into solid current collectors and the electrode assembly precursor powder layers into solid electrode assemblies, and to establish interparticle connections therebetween to form a solid-state battery.

9. The method of claim 8, further comprising applying a localized heat treatment.

10. The method of claim 8 wherein the electrode assembly precursor powder layers include lithium metal oxide particles.

11. The method of claim 8, further comprising applying a solid electrolyte precursor between the electrode assembly precursor powder layers prior to thermocompression.

12. The method of claim 8 wherein the thermocompression is performed at a temperature below 1,000° C.

13. The method of claim 8 wherein the electrode assembly precursor powder layers include a binder additive.

14. A method of forming vertical stack battery comprising:
interleaving electrode assembly particle layers between metal pellet layers within a cylindrical cell; and
applying heat and pressure to the cylindrical cell to compact and sinter the metal pellet layers into solid current collectors and the electrode assembly particle layers into electrode assemblies, and to bond the current collectors to adjacent electrode assemblies to create a solid-state battery structure.

15. The method of claim 14 wherein the electrode assembly particle layers include a mixture of an active material, a conductive additive, and a solid electrolyte.

16. The method of claim 14 wherein the cylindrical cell includes a polymer lining to contain interleaved layers during heating and compression.

17. The method of claim 14 wherein the heat applied to the cylindrical cell is in a range below 1,000° C.

18. The method of claim 14 wherein the pressure applied to the cylindrical cell is in a range of 50 MPa to 200 MPa.

19. The method of claim 14, further comprising encapsulating the solid-state battery structure in a ceramic housing.

20. The method of claim 19 wherein the heat and pressure are applied simultaneously using an induction heating press.
